(19) United States
(12) Patent Application Publication
(10) Pub. No.: US 2014/0214755 A1
(43) Pub. Date: Jul. 31, 2014

(54) EXTENSIBLE MODEL FOR IT RESOURCE CHARGEBACK

(71) Applicant: Hewlett-Packard Development Company, L.P., Houston, TX (US)

(72) Inventors: Glaucimar Da Silva Aguiar, Porto Alegre (BR); Tiago Everton Ferraz Martins, Porto Alegre (BR); Tiago da Silveira Duarte, Sao Paulo (BR)

(73) Assignee: HEWLETT-PACKARD DEVELOPMENT COMPANY, L.P., Houston, TX (US)

(21) Appl. No.: 13/755,819

(22) Filed: Jan. 31, 2013

(51) Int. Cl. G06F 17/30

(52) U.S. Cl. CPC G06F 17/30294
USPC 707/605

(57) ABSTRACT

The present disclosure provides techniques for chargeback of IT resources. Resource change data may be stored until the data is accessed by a chargeback system. The chargeback system may access the resource change data daily and may convert the resource change data to daily resource usage and cost data. The resource usage and cost data may be stored in a chargeback database and the daily usage and cost data may be reported.

### BACKGROUND

Cloud computing refers to the process of utilizing multiple pieces of hardware over a network to perform specific computing tasks. Cloud computing typically employs virtualized resources. A virtual resource is a piece of software configured to emulate a specific piece of hardware or alternatively may serve to abstract a resource that may have been accessed or addressed in a concrete manner. The combination of hardware resources and virtual resources is abstracted to a user or client system.

### BRIEF DESCRIPTION OF THE DRAWINGS

Certain exemplary embodiments are described in the following detailed description and in reference to the drawings, in which:

FIG. 1 is a diagram of a cloud computing system with a chargeback system;

FIG. 2 is a diagram of an example of the chargeback system and an infrastructure management system;

FIGS. 3A-3B are an abstraction of an example of the tables in the staging area;

FIG. 4 is an example of a database schema used by the chargeback system;

FIG. 5 is an example of a relationship in the database schema; and

FIG. 6 is a process flow diagram illustrating a chargeback method.

### DETAILED DESCRIPTION OF SPECIFIC EMBODIMENTS

Embodiments disclosed herein provide techniques for chargeback of IT resources. Defining a chargeback solution for a cloud environment is a difficult task due to growing complexity and evolving characteristics of the cloud environment. The chargeback solution described herein enables a cloud computing service provider to accommodate the pace of innovation and harvest economic value from new concepts still emerging in cloud computing.

Current chargeback, metering, and account systems do not integrate extract, transform, and load (ETL) with data warehousing concepts in a chargeback use case in a way that provides a built-in/pre-configured solution that can be analyzed to support decision processes. In general, chargeback use cases are implemented in terms of a ticket without the capability of daily consolidated view. The implementation of a data warehouse solution requires a large effort of definition, configuration, and database specialists. The integration of the technologies provides a built-in chargeback system that allows some evaluations of trends, frequently used resources, and the like.

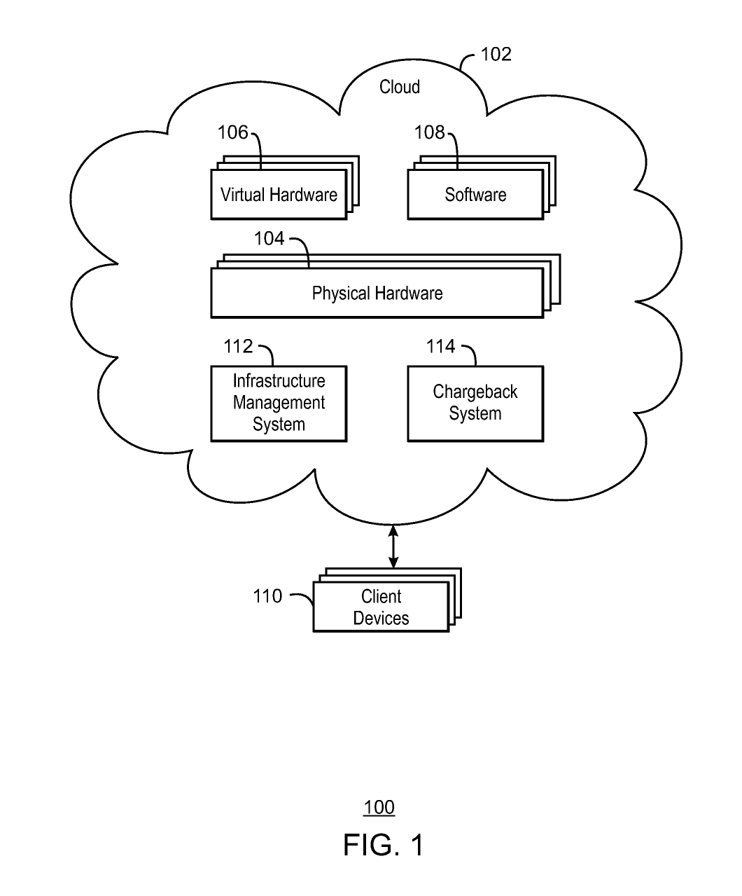

FIG. 1 is a diagram of a cloud computing system with a chargeback system. The cloud computing system 100 can be a public system, a community system, a hybrid system, a private system, or some combination of systems. In an example, a cloud computing system 100 includes a cloud 102 including a combination of physical hardware 104, virtual hardware 106, and software 108. The cloud computing system 100 also includes a client 110. The cloud computing system 100 may include a single client device 110 or multiple client devices 110. The client device 110 can be a desktop computer, a laptop computer, a tablet computer, a cellular phone, such as a smartphone, or any other suitable device. The client device 110 may be coupled to the cloud 102 via a wired connection or a wireless connection. In an example, the client device 110 is coupled to the cloud 102 via an Ethernet connection, a WLAN connection, a LAN connection, or any other suitable connection method. In an example, the cloud 102 receives service requests from a client 110 and returns a service result to the client.

A cloud computing system 100 is a system in which multiple pieces of hardware and software are utilized over a network to perform specific computing tasks. The combination of physical hardware 104, virtual hardware 106, and software 108 is often referred to as the cloud 102. The cloud symbol is often used to represent the abstraction of a network.

Physical hardware 104 may include processors, memory devices, and networking equipment, among others. The physical hardware 104 performs the actual computing and processing required by the cloud computing system 100. For example, the physical hardware 104 performs a computation requested by a client device 110.

Virtual hardware 106 is a type of software that is processed by physical hardware 104 but is designed to emulate a specific set of hardware. For example, a particular piece of software is designed to be run by a specific type of hardware. By running virtual hardware 106 on top of the physical hardware 104, a given piece of hardware can run software designed for many different types of hardware.

Software 108 may be defined as a set of instructions and data configured to cause a processor to perform specific processes. These processes can be used for running applications which are made available to an end user. Software is designed to operate with specific hardware architecture. Hardware architecture may indicate the format of the processor instructions. Thus, one benefit of using virtual hardware is that multiple different hardware components can all operate the same software.

The physical hardware 104, virtual hardware 106, and the software 108 associated with the cloud can be configured to receive service requests from a client device 110. The cloud computing system 100 can then perform the desired processes and return the result to the client device 110.

The cloud computing system 100 may also include an infrastructure management system 112. The infrastructure management system 112 is responsible for managing the computing resources of the cloud computing system 100. For example, infrastructure management system 112 creates new virtual hardware 106 emulated by physical hardware 104 and installs software 108 on either physical hardware 104 or virtual hardware 106.

The cloud computing system 100 further includes a chargeback system 114, which may be coupled to the infrastructure management system 112. The chargeback system 114 is a hardware system including one or more processors. The chargeback system 114 tracks the computing resource usage of the cloud computing system 100 that is attributable to specific users. For example, the chargeback system 114 tracks computing resource usage, such as by a specific user, and the cost of the resource usage on a daily basis. By tracking the computing resource usage of the cloud computing system 100, a client system or device 110 can be charged for the use of resources in a cloud computing system 100.

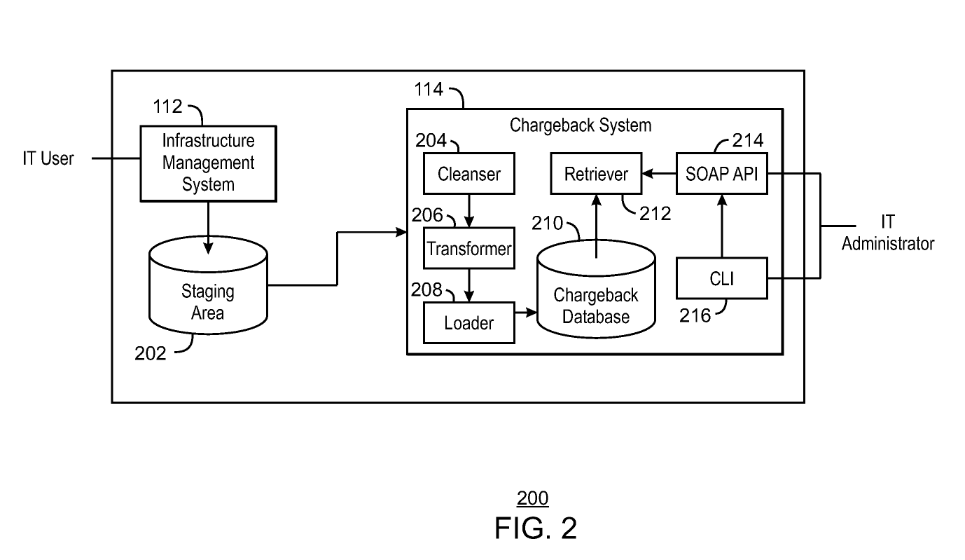

FIG. 2 is a diagram of an example of the chargeback system and an infrastructure management system. The infrastructure management system 112 may be coupled to a chargeback system 114 via a staging area 202. The staging area 202 can record changes in computing resources. For example, recording changes in computing resources include recording the state of the infrastructure of a computing system, such as the cloud computing system 100. The state of the infrastructure can be recorded at the moment of change to the state of the infrastructure. A change in the infrastructure can trigger a recording of the instantaneous state of the infrastructure. In an example, a change in the infrastructure is caused or initiated by a user. The infrastructure management system 112 may log changes to the infrastructure in the staging area 202. Changes to the infrastructure can include changes to the hardware configuration of the virtual hardware 106, changes to physical hardware 104 configuration, changes to the power state, changes to software 108, changes to the cost of computing resources, changes of the owning user, and creation of new virtual hardware 106 or new physical hardware 104. In another example, the staging area monitors the infrastructure for changes. The staging area can also list all policy costs. Policy costs refer to the set cost for use of each resource for a specified period of time. For example, the policy cost can be the cost to a user for the use or allocation of a resource for a specified period of time.

The staging area 202 can store recorded changes in computing resources until the data is accessed by the chargeback system 114. For example, the chargeback system 114 can access the staging area 202 daily, such as at a predetermined period of time each day. In another example, the staging area 202 notifies the chargeback system 114 of resource change data awaiting analysis. The resource change data can be received in the cleanser 204. The cleanser 204 can perform uniformization of the data. For example, the cleanser 204 resolves conflicts within the resource change data. In another example, the cleanser 204 removes inconsistencies within the resource change data.

The resource change data can be passed to a transformer 206. The transformer 206 can perform calculations, such as resource usage calculations. The transformer 206 can also perform resource usage cost calculations. In an example, the cost is based on the resource usage. In an example, the resource usage is calculated first, then used to calculate the cost of the calculate usage. The policy costs may be stored in the staging area 202 and accessed by the chargeback system 114. For example, the policy costs are accessed by the chargeback system 114 when the resource change data is transferred from the staging area 202 to the chargeback system 114.

The resource usage and cost data can be transferred to a loader 208, which loads the data into a chargeback database 210. The chargeback database 210 can be a warehouse-like database. The chargeback database 210 can be pre-defined in terms of charged resources, such as network, servers, disks, and infrastructure services. If a new resource is to be tracked, the chargeback database can add a new definition for the new resource. The chargeback database 210 stores the usage and cost data in tables. Each table can track a particular resource. If a new resource is to be tracked, a new table can be added to the chargeback database 210 to track the new resource. The tables of the chargeback database 210 may be interrelated in a database schema to facilitate information retrieval. For example, the tables are interrelated in a star schema design.

A retriever 212 gathers information from the chargeback database 210. For example, the retriever 212 gathers resource usage and cost data from the chargeback database 210. The retriever 212 can consolidate the gathered data into a daily report of resource usage and cost. In some examples, the retriever 212 gathers resource usage and/or cost data for a period of time determined by a user. The retriever 212 can then consolidate the gathered data into a report.

The information gathered by the retriever 212 may be accessed by another application, such as a billing system. Access to the information gathered by the retriever 212 can be facilitated by a simple object access protocol (SOAP) application programming interface (API) 214. In some examples, the SOAP API 214 is a web services layer allowing another application to access resource usage and cost data. In another example, the SOAP API 214 allows integration with another system.

The information gathered by the retriever 212 may also be accessed by a user. For example, the retriever 212 is accessed by a command line interface (CLI) 216. The CLI 216 can retrieve user data, resource usage data, resource cost data, or any other data requested by a user. In an example, the SOAP API 214 and/or the CLI 216 are accessed by an IT administrator.

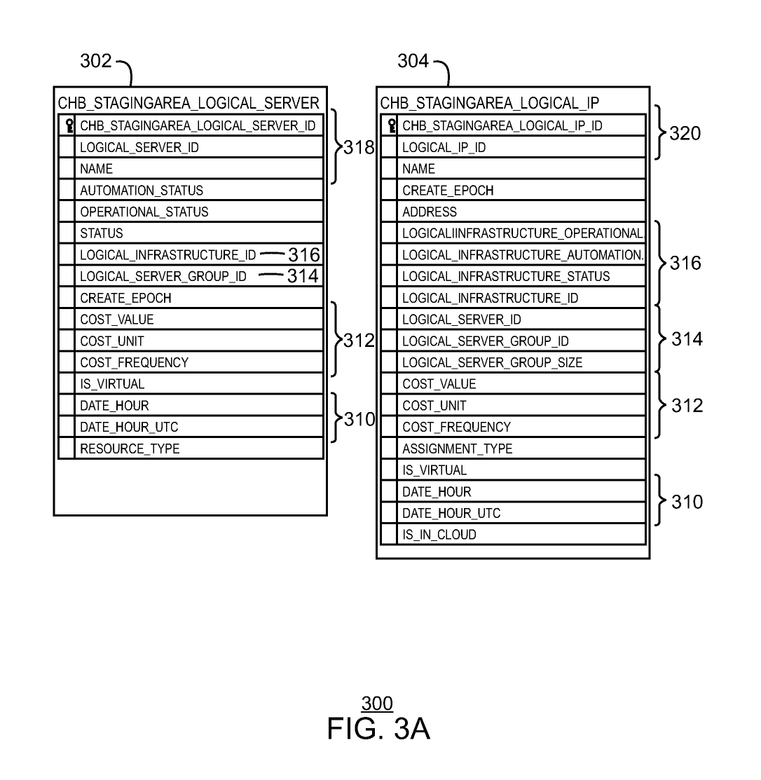

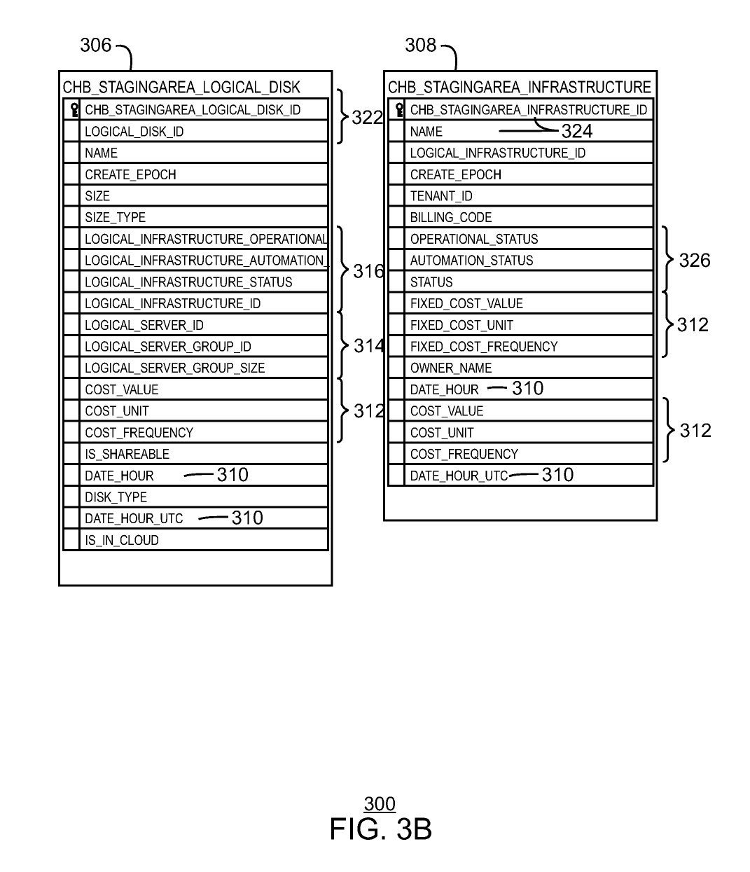

FIGS. 3A-3B are an abstraction of an example of the tables in the staging area. In an example, the staging area includes four tables in which are stored the state of the infrastructure. Each table monitors a type of resource. For example, table 302 monitors the server resource, table 304 monitors the IP resource, table 306 monitors the disk resource, and table 308 monitors the infrastructure resource. Tables 302, 304, 306, and 308 each include date and hour entries 310 that identify a particular date and time that a resource change was made. Tables 302, 304, 306, and 308 each also include cost listings 312 stating the cost of resource usage. Further, as resources are organized in a hierarchy, i.e. an infrastructure with a set of servers, tables 302, 304, and 306 each include references to the server 314 and the infrastructure 316.

Table 302 lists all information relating to the server resource, including multiple server resources present in the computing system. Each server resource 318 is included in table 302, which is updated with each server resource data change. The status 316 of each server resource is also included in table 302.

Similar to table 302, table 304 lists all information relating the IP resource. All IP resources 320 in the computing system and the corresponding changes to the IP resources are tracked by table 304. In addition, table 304 lists information relating to the date and time 310, the cost 312, and the server 314 and infrastructure 316.

As with tables 302 and 304, table 306 lists all information relating to the disk resource. All disk resources 322 in the computing system and their corresponding changes are tracked by table 306. Table 306 also lists information relating to date and time 310, cost 312, the server 314, and the infrastructure 316.

Table 308 lists all information relating to the infrastructure resource. All infrastructure resources 324 in the computing system are tracked by table 308, as are all changes to the infrastructure resources. Table 308 also tracks date and time 310, cost 312, and status 326.

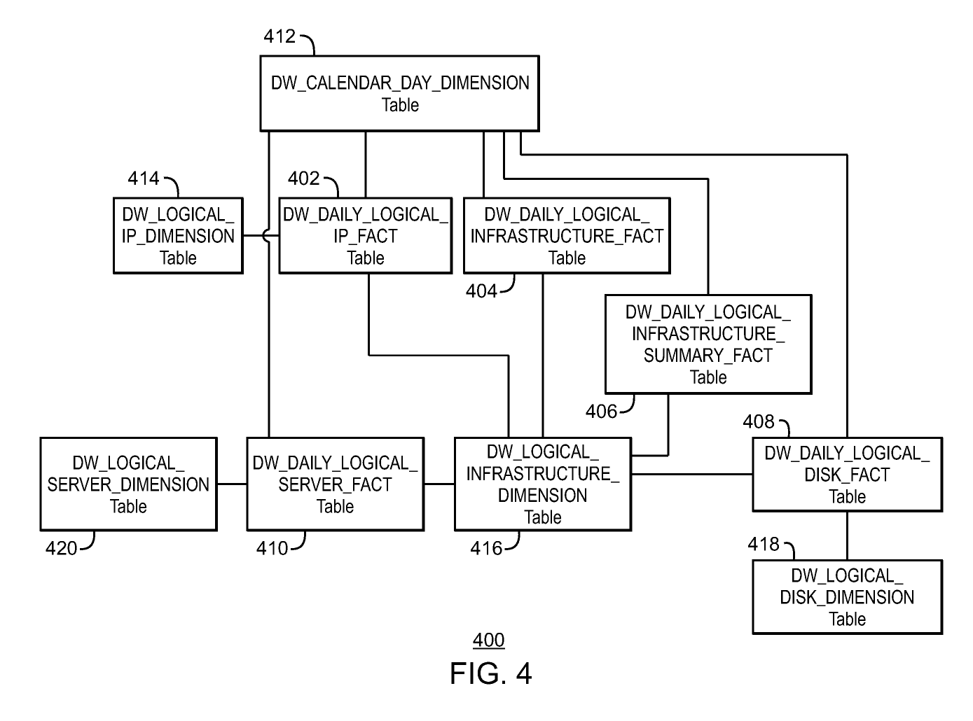

The infrastructure as a whole can be recorded when a change occurs. The infrastructure may be saved in each table and can be used to perform usage and cost calculations. Each table can be interrelated to the remaining tables, such as by references within each table to the other resources. This relationship will be discussed in greater detail in regards to FIG. 4.

FIG. 4 is an example of a database schema used by the chargeback system. The data can be recorded in a variety of tables, resulting in different levels of abstraction of the data. By including different levels, a variety of data queries can be performed. In an example, the database schema is a star schema design. The database schema can include a main table, such as a fact table. The schema can include multiple fact tables 402, 404, 406, 408, and/or 410, each fact table tracking a resource type. For example, table 402 tracks IP resources, table 404 tracks infrastructure resources, table 406 summarizes all resources, table 408 tracks disk resources, and table 410 tracks server resources. The fact table may store compiled values, such as compiled usage and cost data. Each fact table 402, 404, 408, and 410 stores usage and cost data for the resource the table tracks. The fact table can be associated with at least one additional table. For example, the fact table can be associated with a dimension table 412, 414, 416, 418, and/or 420, a table storing information that does not change about a resource, i.e. information other than usage and cost data.

Each fact table can be associated with a single dimension table or multiple dimension tables. In addition, each dimension table may be associated with multiple fact tables. For example, each fact table 402, 404, 406, 408, and 410 is associated with calendar dimension table 412. Calendar dimension table 412 stores full date information, including day, week, month, and year, allowing usage and cost data to reference the particular day on which they occur. Fact table 402 is additionally associated with dimension tables 414 and 416. Dimension table 414 stores static information about all IP resources, such as the IP address and type of each IP resource. Dimension table 416 stores static information about all infrastructure resources, such as organization, billing code and owner. Fact table 404 is associated with calendar dimension table 412, as well as dimension table 416. Fact table 406 is also associated with calendar dimension table 412 and dimension table 416. Fact table 408 is associated with calendar dimension table 412, as well as dimension tables 416 and 418. Dimension table 418 stores static information about all disk resources. Fact table 410 is associated with calendar dimension table 412, as well as dimension tables 416 and 420. Dimension table 420 stores static information about all server resources.

There can be several levels within each table. The levels within the tables allow for an amount of flexibility in data retrieval. For example, data can be searched for by different types of dimensions and in a variety of levels.

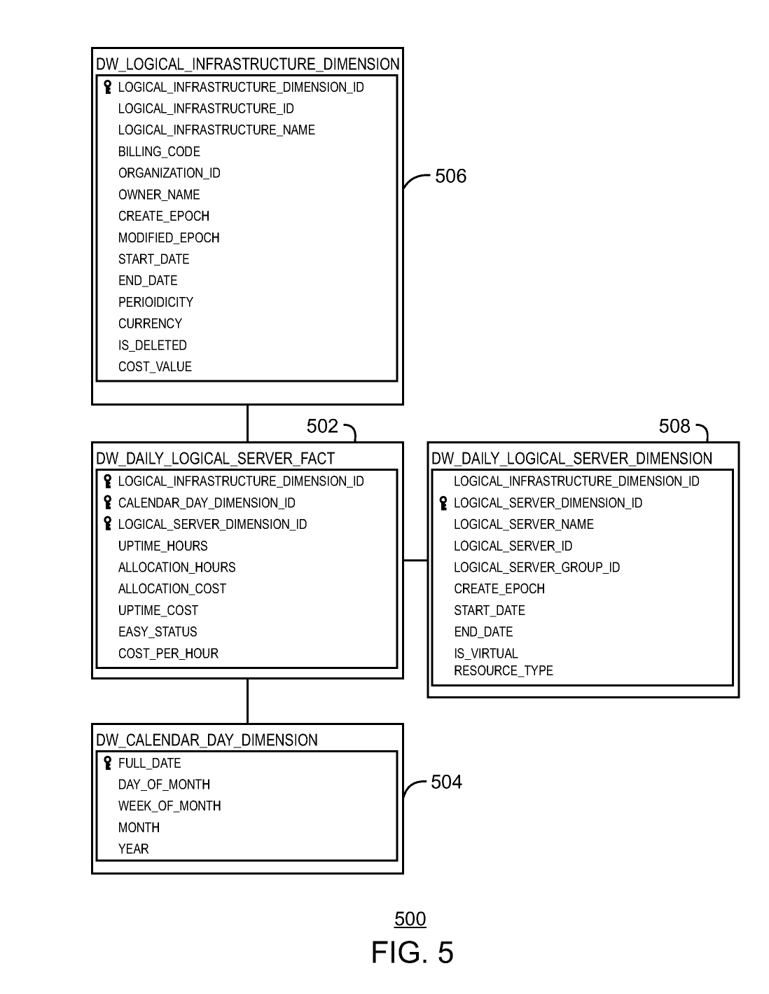

FIG. 5 is an example of a relationship in the database schema. A fact table, such as server fact table 502, can store data usage and cost information. The information stored in the fact table can be modified or added to. The server fact table 502 can be associated with at least one dimension table. For example, the server fact table 502 is associated with a calendar dimension table 504 in order to relate usage and cost data to a particular day and/or time. The server fact table 502 can also be associated with an infrastructure dimension table 506. The infrastructure dimension table 506 can store information associated with the infrastructure that does not change. The server fact table 502 can additionally be associated with a server dimension table 508. The server dimension table 508 can store information that does not change, which is associated with the server. Additional relationships, such as relationships arranged similarly to the relationship described here, may be present within a database schema and each relationship may be interrelated with each other. For example, each dimension table associated with a fact table is associated with another fact table.

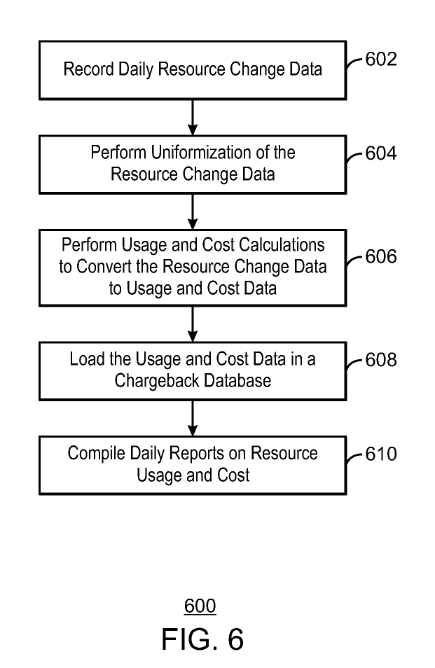

FIG. 6 is a process flow diagram illustrating a chargeback method. The chargeback method 600 can begin at block 602 with recording of daily resource change data. In an example, the resource change data are daily recorded changes to computing resource status, such as changes to computing resource status within a cloud computing system. In an example, the resource change data is a recording of the state of the infrastructure at a moment of change. In an example, the recording is triggered by the change in resource status. In an example, the resource change data is stored in a staging area before being accessed by a chargeback system, such as chargeback system 114. The data may be received in the chargeback system when the chargeback system accesses the staging area. In another example, the staging area notifies the chargeback system of data awaiting analysis. In a further example, the resource change data is transferred to the chargeback system at a predetermined time each day. The predetermined time can be set by a user, such as an IT administrator.

At block 604, uniformization of the resource change data is performed. Uniformization can include removing inconsistencies within the resource change data. In another example, uniformization includes resolving conflicts with the resource change data.

At block 606, the resource change data is converted to usage and cost data. The resource change data can be converted by performing usage calculations and cost calculations using the resource change data. Usage refers to the length of time a particular resource was in use. For example, usage may refer to how long a server was up or how long a disk or network was in use. Policy costs, the set cost for use of each resource for a specified period of time, can be stored within the staging area and can be accessed or transferred along with the resource change data. The cost can be based on the usage. In an example, the usage is calculated, then the cost of the calculated usage is determined. The data can be converted daily, such as at a predetermined time. The predetermined time can be selected by a user, such as an IT administrator.

At block 608 the usage and cost data can be loaded in a chargeback database. For example, a loader 208 loads the usage and cost data in chargeback database 210. The chargeback database can be a warehouse-like database. The data within the chargeback database is stored in tables. The tables may be interrelated in a database schema to facilitate data retrieval. In an example, the database schema is a star schema design, such as schema design 400. The database can be pre-defined in terms of IT charged resources. For example, the database is pre-defined in terms of network, servers, disks, and infrastructure services. In an example, if a new resource is to be monitored, an additional table is added to the chargeback database.

At block 610, daily reports on resource usage and cost are compiled. Logic, such as retriever 212, gathers usage and cost data from the chargeback database to compile the daily reports. The daily reports can include consolidated data for all infrastructure services managed by the infrastructure management system. The daily reports may be organized in a particular manner, such as a manner specified by a user. For example, the daily reports are organize and filtered by different attributes, such as organization, billing code, owner, and service name. The daily reports may be accessed by a user or another application. The daily reports can be used to charge users for resource usage. The daily reports can also be used to internally judge resource usage. For example, the daily reports are used to evaluate trends in resource usage and to identify high areas of resource usage. In addition, the daily compilation of resource usage and cost allows the chargeback data for a specified period of time to be retrieved very quickly. For example, the chargeback data for an entire year can be extracted within minutes.

The chargeback system 114 can be embodied in code stored on tangible, non-transitory, computer-readable storage medium. The code is executed by a processor. The code causes the processor to receive resource change data, convert the resource change data to usage and cost data, and store the usage and cost data in a chargeback database. The resource change data includes recordings of a state of infrastructure taken at particular moments in time, such as at the time of a change. The resource change data is converted to usage and cost data via usage calculations and cost calculations. The resource cost depends upon the resource usage. The usage and cost data may be stored in tables within the chargeback database. The tables each track an individual resource and the tables may be interrelated in a database schema, such as a star schema design, to facilitate data retrieval. In an example, the resource monitored by each table is one of server, IP, disk, and infrastructure. The resource usage and cost data can be converted and compiled daily and reported to a user.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A method for IT resource chargeback, comprising:
receiving, in a chargeback system, resource change data comprising daily recorded changes to computing resource status of a cloud computing environment;
converting the data to daily usage and cost data;
recording the daily usage and cost data in a chargeback database; and
generating a report of the daily usage and cost data.

2. The method of claim 1, wherein the resource change data comprises a recording of a state of a computing infrastructure at a moment of change, wherein the recording is triggered at the moment of change.

3. The method of claim 1, wherein the resource change data is recorded in a staging area until the data is received in the chargeback system.

4. The method of claim 3, wherein the staging area stores the data in a table and wherein each table monitors a type of resource.

5. The method of claim 4, wherein the type of resource is one of server, IP, disk, and infrastructure.

6. The method of claim 1, wherein the chargeback database records the daily usage and cost data in a table, and wherein tables in the chargeback database are related in a star schema design.

7. A system for IT resource chargeback, comprising:
an infrastructure management system to manage computing resources; and
a chargeback system to track daily usage of computing resources, the chargeback system comprising:
a transformer to convert resource change data comprising daily changes to computing resource status to daily usage and cost data; and
a chargeback database to store the daily usage and cost data.

8. The system of claim 7, wherein the resource change data is recorded in a staging area until the data is received in the chargeback system.

9. The system of claim 8, wherein the staging area stores the data in a table and wherein each table monitors a type of resource.

10. The system of claim 9, wherein the type of resource is one of server, IP, disk, and infrastructure.

11. The system of claim 7, wherein the resource change data comprises a recording of a state of a computing infrastructure at a moment of change, wherein the recording is triggered at the moment of change.

12. The system of claim 7, wherein the daily usage and cost data is stored in at least one table within the chargeback database.

13. The system of claim 7, wherein tables within the chargeback database are related in a star schema design.

14. The system of claim 7, wherein the chargeback system executes on a daily basis.

15. The system of claim 7, wherein the system is a cloud computing system.

16. A tangible, non-transitory, computer-readable storage medium, comprising code for IT resource chargeback that, when executed, causes a processor to:
receive resource change data comprising daily recorded changes to computing resource status;
convert the data to daily usage and cost data; and
store the daily usage and cost data in a chargeback database.

17. The tangible, non-transitory, computer-readable storage medium of claim 16, wherein the resource change data comprises a recording of a state of a system infrastructure at a moment of change within the system infrastructure, wherein the recording is triggered at a change to the system infrastructure.

18. The tangible, non-transitory, computer-readable storage medium of claim 16, wherein the daily usage and cost data is stored in at least one table within the chargeback database and wherein each table monitors a type of resource.

19. The tangible, non-transitory, computer-readable storage medium of claim 16, wherein tables within the chargeback database are related in a star schema design.

20. The tangible, non-transitory, computer-readable storage medium of claim 16, wherein a staging area records the resource change data until the data is accessed by the chargeback system, wherein the staging area records the data in tables and wherein each table monitors a type of resource.
